(19) United States
(12) Patent Application Publication
(10) Pub. No.: US 2026/0008940 A1
(43) Pub. Date: Jan. 8, 2026

(54) Self-Healing Paint Protection Film

(71) Applicant: SANGBO CORPORATION, Gimpo-si, Gyeonggi-do (KR)

(72) Inventors: Hyun Soo CHA, Gimpo-si, Gyeonggi-do (KR); Su Youn BAE, Gimpo-si, Gyeonggi-do (KR); Jong Gyuong LEE, Gimpo-si, Gyeonggi-do (KR); Tae Won KIM, Gimpo-si, Gyeonggi-do (KR)

(21) Appl. No.: 18/993,880

(22) PCT Filed: Jul. 3, 2023
(86) PCT No.: PCT/KR2023/009321

§ 371 Date: Jan. 13, 2025

(30) Foreign Application Priority Data
Jul. 18, 2022 (KR) 10-2022-0088561

(51) Int. Cl. C09J 7/29

(52) U.S. Cl. CPC C09J 7/29; C09J 2301/162; C09J 2475/006

(57) ABSTRACT

A self-healing paint protection film includes: a substrate layer including a thermosetting polyurethane resin and a curing agent; a top coating layer formed on one side of the substrate; an adhesive layer formed on the other side of the substrate layer; and a pattern layer formed between the substrate layer and the top coating layer, wherein a polyester-based resin having a weight-average molecular weight of 40,000 to 60,000 and a glass transition temperature of 20° C. to 60° C. is used as the thermosetting polyurethane resin, and therefore the paint protection film has excellent elasticity, is easy to apply, enhances paint visibility, and exhibits excellent self-healing properties through contraction and relaxation, thus being appropriate for use on curved surfaces of automobiles and the like.

### TECHNICAL FIELD

The present invention relates to a self-healing paint protection film, and more specifically, to a self-healing paint protection film characterized by comprising: a substrate layer including a thermosetting polyurethane resin and curing agent; a top coating layer formed on one side of the substrate; an adhesive layer formed on the other side of the substrate layer; and a pattern layer formed between the substrate layer and the top coating layer, wherein a polyester-based resin having a weight-average molecular weight of 40,000 to 60,000 and a glass transition temperature of 20° C. to 60° C. is used as the thermosetting polyurethane resin, and therefore the paint protection film has excellent elasticity, is easy to apply, enhances paint visibility, and exhibits excellent self-healing properties through contraction and relaxation, thus being appropriate for use on curved surfaces of automobiles and the like.

### BACKGROUND ART

On the surfaces of transportation means such as ships and automobiles, paint formed by mixing pigments and solvents is applied to protect the surface. When paint is damaged or peels off, its anti-corrosion and moisture-proofing functions are weakened. Conventional paint protection films were primarily developed to protect surfaces of ships, aircraft, and helicopters from sand and flying debris, with main purpose of preventing paint from peeling off surface of transportation vehicle.

While these films protect paint, they fall short of providing same effect as paint itself, and applying self-healing paint protection film to curved surfaces is not popularly used because it is quite challenging, requiring skilled professionals to handle task, and having burden of cost.

Conventional paint protection films using thermoplastic polyurethane (TPU) can be easily attached to curved surfaces due to their excellent flexibility, but have drawbacks such as easily contaminated surfaces and insufficient self-healing properties after stretching. Particularly, paint protection films often have added designs such as patterns or motifs. Paint protection films with such design applied are stretched by installers before attachment for curved surface application, but there are many cases where designs or patterns stretched along with substrate layer of film are not restored after construction, causing aesthetic damage. In other words, conventional paint protection films lack elasticity in response to contraction and relaxation, making installation difficult. Additionally, when thickness is increased for better stretchability, conventional paint protection films suffer from reduced transmittance, preventing full expression of vehicle paint color. Therefore, the present disclosure aims to provide a paint protection film with excellent elasticity for easy application, improved paint visibility, and superior self-healing properties in response to contraction and relaxation.

### DISCLOSURE

### Technical Problem

Accordingly, the present disclosure has been made keeping in mind the above problems occurring in the related art.

An objective of the present disclosure is to provide a self-healing paint protection film with improved elasticity and excellent workability, comprising a substrate layer containing thermosetting polyurethane resin and curing agent, a top coating layer formed on one side of the substrate layer, an adhesive layer formed on another side of the substrate layer, wherein the thermosetting polyurethane resin uses polyester-based resin.

Another objective of the present disclosure is to provide a self-healing paint protection film with superior elongation compared to conventional protective films including substrate layers of thermoplastic polyurethane, by using polyester-based resin with a weight average molecular weight of 40,000 to 60,000 and a glass transition temperature of 20° C. to 60° C.

Another objective of the present disclosure is to provide a self-healing paint protection film with improved elongation and prevention of haze phenomenon, by including 2 to 5 parts by weight of curing agent in the substrate layer, wherein the curing agent is an isocyanate-based curing agent or adduct.

Another objective of the present disclosure is to provide a self-healing paint protection film with enhanced aesthetics by more including pattern layer between the substrate layer and the top coating layer.

Another objective of the present disclosure is to provide a self-healing paint protection film with improved separation resistance between substrate layer and pattern layer and simplified manufacturing, wherein the pattern layer protrusions and depressions, formed by applying protrusions and depressions to a part of the substrate layer, and is formed by laminating a film with protrusions and depressions on the substrate layer, curing the film, and then removing the film with protrusions and depressions.

### Technical Solution

The present disclosure may be implemented by one or more embodiments having some or all of the following configurations.

According to one embodiment of the present disclosure, a self-healing paint protection film comprising a substrate layer containing thermosetting polyurethane resin and curing agent, a top coating layer formed on one side of the substrate layer, an adhesive layer formed on the other side of the substrate layer, where the thermosetting polyurethane resin is a polyester-based resin.

According to one embodiment of the present disclosure, the polyester-based resin has a weight average molecular weight of 40,000 to 60,000 and a glass transition temperature of 20° C. to 60° C.

According to one embodiment of the present disclosure, the curing agent is an isocyanate-based curing agent or adduct, and is included in the substrate layer at 2 to 5 parts by weight.

According to one embodiment of the present disclosure, a pattern layer is additionally included between the substrate layer and the top coating layer.

According to one embodiment of the present disclosure, the pattern layer has protrusions and depressions and is formed by applying protrusions and depressions to part of the substrate layer.

According to one embodiment of the present disclosure, the pattern layer is formed by laminating a film with protrusions and depressions onto the substrate layer, curing, and then removing the film.

According to one embodiment of the present disclosure, pigments are incorporated into the substrate layer and pattern layer, forming a colored pattern in the pattern layer.

### Advantageous Effects

The present disclosure may achieve the follow effects from the embodiment and configurations described below, as well as combinations and relationships of use thereof.

According to the present disclosure, the present disclosure provides a self-healing paint protection film with improved elasticity and ease of application, comprising a substrate layer containing thermosetting polyurethane resin and curing agent, a top coating layer formed on one side of the substrate layer, and an adhesive layer formed on the other side of the substrate layer, where the thermosetting polyurethane resin uses a polyester-based resin.

Furthermore, according to the present disclosure, the present disclosure provides a self-healing paint protection film with superior elongation compared to conventional thermoplastic polyurethane substrate layer films, by using a polyester-based resin with a weight average molecular weight of 40,000 to 60,000 and a glass transition temperature of 20° C. to 60° C.

Additionally, according to the present disclosure, the present disclosure provides a self-healing paint protection film with improved elongation and prevention of haze phenomenon, by including 2 to 5 parts by weight of an isocyanate-based curing agent or adduct in the substrate layer.

Moreover, according to the present disclosure, the present disclosure provides a self-healing paint protection film with enhanced aesthetics by including a pattern layer between the substrate layer and the top coating layer.

Furthermore, according to the present disclosure, the present disclosure provides a self-healing paint protection film with improved interlayer adhesion and simplified manufacturing, by applying protrusions and depressions to part of the substrate layer to form the pattern layer, and by laminating a film with protrusions and depressions onto the substrate layer, curing, and then removing the film.

### DESCRIPTION OF DRAWINGS

FIG. 1 is a cross-sectional view illustrating a self-healing paint protection film according to one embodiment of the present disclosure.

FIG. 2 is a cross-sectional view illustrating a self-healing paint protection film according to another embodiment of the present disclosure.

FIG. 3 illustrates types of patterns formed in pattern layer (15) of the present disclosure.

FIG. 4 shows photographs of films formed according to Example 3 and Comparative Example 1 before stretching, immediately after stretching, and after recovery.

### MODE FOR INVENTION

Hereinafter, the self-healing paint protection film according to the present disclosure will be described in detail with reference to the accompanying drawings. Also, detailed descriptions of known functions and configurations that may unnecessarily obscure the gist of the present disclosure are omitted. Unless defined otherwise, all terms used herein have same meaning as understood by those skilled in the art to which the present disclosure belongs, and in case of conflict with the meaning of a term used herein, the definition used herein shall apply.

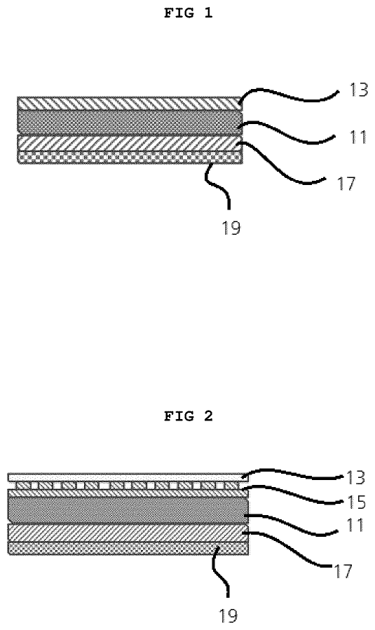

FIG. 1 is a cross-sectional view illustrating self-healing paint protection film 1 according to an embodiment of the present disclosure. The self-healing paint protection film 1 has a multi-layer structure and may include substrate layer 11 as a first layer and a top coating layer 13 as a second layer. Additionally, referring to FIG. 2, the self-healing paint protection film 1 may include pattern layer 15 as a third layer between the substrate layer 11 as first layer and the top coating layer 13 as second layer. The self-healing paint protection film 1 may preferably include an adhesive layer 17 formed of a pressure-sensitive adhesive, and a release liner 19 releasably bonded to the adhesive layer 17 to protect adhesive layer 17.

The substrate layer 11 can be a thermosetting polyurethane layer. Thermosetting polyurethane is formed by mixing diol or polyol, solvent and isocyanate-based curing agent, and a reaction retardant may be incorporated. Thermosetting polyurethane layer 11 according to the present disclosure has excellent elasticity, improving workability of self-healing paint protection film, and has excellent transmittance, enhancing visibility of surface to be adhered, such as vehicle surface. In the case of conventional protective films primarily composed of thermoplastic polyurethane (TPU) as main component, a certain degree of ductility can be achieved due to thermoplastic nature of polyurethane, but it is difficult to control thickness of thermoplastic polyurethane (TPU) layer and has disadvantage of poor self-healing property, and as described above, due to insufficient self-healing property, when a film with design such as motif or pattern is applied to painted surface, stretched design of patter is not restored after installation. Thermosetting polyurethane layer according to present disclosure can improve elasticity and durability of substrate layer 11 and self-healing paint protection film 1 by using polyester-based resin as main component. The inventors have discovered that elasticity and transmittance are particularly excellent within a certain range of molecular weight and glass transition temperature, leading to present disclosure. Polyester-based resin is preferably included in films attached to exterior surfaces of transportation means such as automobiles due to its excellent elasticity, durability, and strength. The polyester-based resin preferably has a weight average molecular weight of 40,000 to 60,000 and a glass transition temperature of 20° C. to 60° C. Within the range of molecular weight and glass transition temperature, it stretches smoothly and exhibits good self-healing properties, returning to its original state after stretching.

Thermosetting polyurethane resin can be used in an amount of 30 to 40 parts by weight based on weight of thermosetting polyurethane layer solution. If molecular weight of resin is too low, coating properties are poor due to uneven dispersion, resulting in poor appearance even when film is applied to adhered surface, and if molecular weight is too high, there is a problem of reduced elasticity and recovery force.

Solvent for the thermosetting polyurethane layer can be MEK (methyl ethyl ketone), toluene, or a mixture thereof, and solvent can be mixed in an amount of 50 to 70 parts by weight based on weight of thermosetting polyurethane layer solution.

Curing agent can use one or more of isocyanate, epoxy, and metal chelate, and isocyanate-based curing agent and isocyanate-based adducts can be used as curing agent. The adduct is an additional product of curing agent, which may have at least one isocyanate group. Isocyanate-based curing agent can be used in an amount of 2 to 5 parts by weight based on weight of thermosetting polyurethane layer solution. As the curing agent is used in an amount of 2 to 5 parts by weight, thermosetting polyurethane layer can have elasticity that stretches when extended. Accordingly, film according to present disclosure can be smoothly attached or applied to adhered surface.

Acetylacetone is preferably used as reaction retardant, and it can be used in an amount of 0.1 to 1 part by weight based on 100 parts by weight of thermosetting polyurethane layer solution.

Additionally, pigments may be incorporated into substrate layer 11. Pigments can be defined as particulate inorganic or organic compounds that do not dissolve in solvents and have a certain color. Pearl can be used to give film a shining or sparkling effect by reflecting light from light source, and preferably, color-changing pearls that change color depending on viewing angle of film can be used. Color pigments can be used to give color to film. Due to these characteristics of pearls and pigments, when dispersion of pearls in resin is good, visible light reflectance (VLR) can be favorable, and when dispersion of pigments in resin is good, visible light transmittance (VLT) can be low. In other words, when compatibility between resin and pearl is good, reflectance (VLR) tends to increase, and when compatibility between resin and pigment is good, transmittance (VLT) tends to decrease. Additionally, as pigments are incorporated, colored patterns can be formed in pattern layer 15, which will be described later.

The top coating layer 13 can be provided to protect substrate layer by being applied on one side of thermosetting polyurethane layer 11, which is substrate layer, and protects substrate layer from collisions with foreign substances such as soil, sand, and asphalt fragments. The top coating layer 13 can be formed using thermosetting, thermoplastic, or photo-curable resins. Polycarbonate resin, acrylic resin, polyester resin, phenoxy resin, epoxy resin, polyolefin resin, fluoroethyl vinyl ether (FEVE) resin, etc. can be used as thermosetting resins, while polypropylene resin, polycarbonate resin, acrylic resin, polystyrene resin, etc. can be used as thermoplastic resins. Urethane acrylate resin, polyester acrylate resin, etc. can be used as photo-curable resins, and other resins suitable for top coating layers can also be used. The top coating layer 13 is preferably made to have self-healing properties. In one embodiment, the top coating layer 13 may include fluorine compounds to ensure anti-fouling and durability, and is preferably fluoroethylene vinyl ether (FEVE).

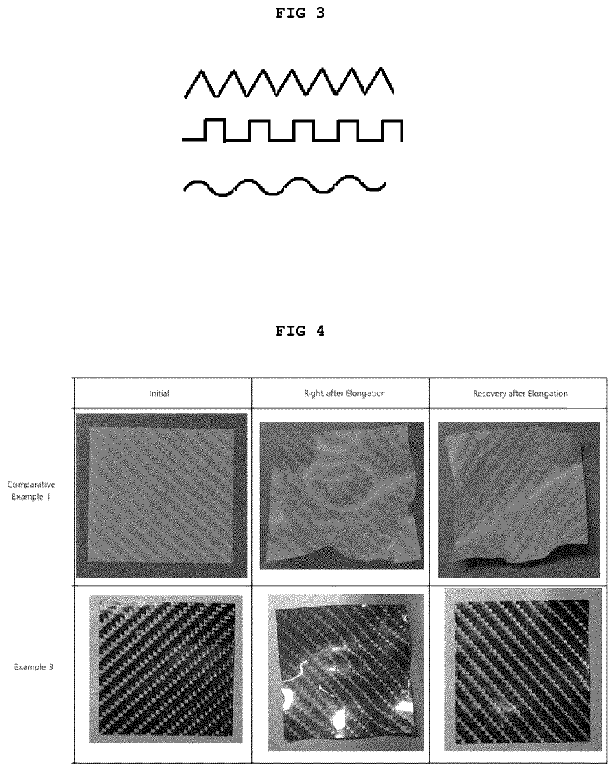

The pattern layer 15 is formed between substrate layer 11 and top coating layer 13, and the pattern layer 15 can preferably form patterns along regularly or irregularly repeating protrusions and depressions. At this time, the pattern formed in pattern layer can have a shape where peaks and valleys are repeated, or convex and concave parts extended to a certain length are repeated, or protrusions and depressions formed with rounded curved surfaces can be repeated as shown in FIG. 3. The pattern layer 15 can also form motifs, designs, or patterns that are not protrusions and depressions.

In a preferred embodiment, the pattern layer 15 can be formed by applying protrusions and depressions to a portion of substrate layer 11. After applying thermosetting polyurethane resin as substrate layer 11, a film with protrusions and depressions is laminated on the surface of the substrate layer, cured, and then the film with protrusions and depressions is removed, forming a predetermined thickness of a substrate layer into a pattern layer 15 with protrusions and depressions.

In another embodiment, the pattern layer 15 can be a layer formed independently from substrate layer 11. In this case, pattern layer 15 can use thermoplastic polyurethane mixed with known polyols such as polycarbonate-based or polyester-based polyols and curing agents such as isocyanate, and can also use thermosetting or photo-curable polyurethane. When the pattern layer 15 is formed independently from substrate layer 11, pigments can be incorporated into pattern layer 15 to give it color.

When pigments are not incorporated into substrate layer 11 and pattern layer 15, a transparent self-healing paint protection film can be formed, improving visibility.

Adhesive layer 17 was formed by laminating acrylic pressure-sensitive adhesive, etc on release liner through heat, and known compositions such as release paper can be used as release liner 19.

### EXAMPLE 1

A dispersion solution for substrate layer 11 of thermosetting polyurethane was formed by mixing 35 wt % of polyester-based polyurethane resin (urethane resin from Toyo Ink Paint Co., Japan) with glass transition temperature (Tg) of 40° C. and weight average molecular weight of 40,000-60,000, 37 wt % of MEK (methyl ethyl ketone, from SamChun Chemical Co., Ltd., Korea) as solvent, 25 wt % of toluene (from SamChun Chemical Co., Ltd., Korea) as solvent, 1 wt % of isocyanate-based curing agent (Coronate HX from Tosoh Corp., Japan) as curing agent, 1 wt % of acetylacetone (from Daejung Chemicals & Metals Co., Korea) as reaction retardant, and dispersing 1 wt % of color pigment (carbon black from OCI Co., Korea) with particle diameter of 1 μm to 5 μm, exhibiting a carbon black color.

For top coating layer 13, a solution of thermoplastic polyurethane (TPU, 49510-60DV from SWM Co., USA) mixed with polycarbonate-based polyol and isocyanate-based curing agent was used, and for adhesive layer 17, acrylic pressure-sensitive adhesive (op-3510-2 from AICA Co., Japan) on release liner was used.

These solutions were layered in membrane form to create a self-healing paint protection film. Thermosetting polyurethane solution, which is the substrate layer 11, was formed by casting or coating on a releasable carrier web or liner, and top coating layer 13 was formed by casting or coating on a releasable carrier web or liner and then casting on one side of substrate layer 11. During curing process, a film with protrusions and depressions was laminated on one side of substrate layer 11, and after curing and aging, film with protrusions and depressions was removed to form pattern layer 15 with thermosetting polyurethane composition. Adhesive layer 17 was formed by applying a coating layer to release film and then transfer coating.

### EXAMPLE 2

Curing agent was dispersed 2 wt % in substrate layer 11 as thermosetting polyurethane layer of Example 1, and film was formed with MEK content as solvent reduced by the amount of increase in curing agent content. In subsequent examples, solvent content was also changed to correspond to changes in curing agent content.

### EXAMPLE 3

A self-healing paint protection film was formed with 3 wt % of curing agent dispersed in substrate layer 11 of Example 1.

### Example 4

A self-healing paint protection film was formed with 4 wt % of curing agent dispersed in substrate layer 11 of Example 1.

### EXAMPLE 5

A self-healing paint protection film was formed with 5 wt % of curing agent dispersed in substrate layer 11 of Example 1.

### EXAMPLE 6

A self-healing paint protection film was formed with 6 wt % of curing agent dispersed in substrate layer 11 of Example 1.

### EXAMPLE 7

A self-healing paint protection film was formed with 7 wt % of curing agent dispersed in substrate layer 11 of Example 1.

### EXAMPLE 8

A self-healing paint protection film was formed with polyester-based resin having a glass transition temperature (Tg) of 10° C. constituting substrate layer 11 of Example 3. Specifically, 35 wt % polyester-based polyurethane resin (Toyo Ink Paint Co., Japan) with glass transition temperature (Tg) 10° C., weight average molecular weight 40,000˜60,000, 36 wt % MEK as solvent, 25 wt % toluene as solvent, 3 wt % isocyanate-based curing agent as curing agent, 1 wt % acetylacetone as reaction retardant were mixed. At this time, a film with substrate layer 11 not including color pigments was formed.

### EXAMPLE 9

A self-healing paint protection film was formed with polyester-based resin constituting substrate layer 11 of Example 8 having a glass transition temperature (Tg) of 20° C.

### EXAMPLE 10

A self-healing paint protection film was formed with polyester-based resin constituting substrate layer 11 of Example 8 having a glass transition temperature (Tg) of 30° C.

### EXAMPLE 11

A self-healing paint protection film was formed with polyester-based resin constituting substrate layer 11 of Example 8 having a glass transition temperature (Tg) of 40° C.

### EXAMPLE 12

A self-healing paint protection film was formed with polyester-based resin constituting substrate layer 11 of Example 8 having a glass transition temperature (Tg) of 50° C.

### EXAMPLE 13

A self-healing paint protection film was formed with polyester-based resin constituting substrate layer 11 of Example 8 having a glass transition temperature (Tg) of 60° C.

### EXAMPLE 14

A self-healing paint protection film was formed with polyester-based resin constituting substrate layer 11 of Example 8 having a glass transition temperature (Tg) of 70° C.

### EXAMPLE 15

A self-healing paint protection film was formed with polyester-based resin constituting substrate layer 11 of Example 8 having a glass transition temperature (Tg) of 80° C.

### EXAMPLE 16

A self-healing paint protection film was formed with polyester-based resin constituting substrate layer 11 of Example 8 having a glass transition temperature (Tg) of 90° C.

### EXAMPLE 17

A self-healing paint protection film was formed with polyester-based resin constituting substrate layer 11 of Example 8 having a glass transition temperature (Tg) of 100° C.

### Comparative Example 1

A self-healing paint protection film was formed by changing substrate layer 11 of Example 10 to a thermoplastic polyurethane (TPU, SWM Co. USA 49510-60DV) layer.

### Comparative Example 2

A self-healing paint protection film was formed by changing substrate layer 11 of Example 10 to a polyethylene terephthalate (Toray Advanced Materials Korea) layer.

### Elongation Evaluation

To evaluate degree of elongation of films according to curing agent content, films formed by Examples 1 to 7 were cut to a size of 10 mm width and 40 mm length, and then elongation tests were performed according to ASTM D638 standard.

TABLE 1

| | Example | | | | | | |
|---|---|---|---|---|---|---|---|
| | 1 | 2 | 3 | 4 | 5 | 6 | 7 |
| Elongation(%) | 190 | 320 | 324 | 324 | 320 | 191 | 170 |

As shown in Table 1, an increase in elongation of protective film could be confirmed within a certain range of curing agent content. A section showing over 300% of elongation was observed depending on content, and through this, it can be seen that elasticity of thermosetting polyurethane layer greatly increases when 2 to 5 parts by weight of isocyanate curing agent is included.

### Elongation and Transmittance Evaluation

Next, to evaluate degree of elongation of films according to glass transition temperature of polyester-based resin, protective films formed by Examples 8 to 17 were cut to a size of 10 mm width and 40 mm length, and then elongation and transmittance tests were performed at same thickness. Elongation test followed ASTM D638 standard, and transmittance test followed methods of COH-400 (equipment name); JIS K 7105/ASTM D1003. Elongation and transmittance are both measured in percentage (%).

TABLE 2

| | Example | | | | | | | | | |
|---|---|---|---|---|---|---|---|---|---|---|
| | 8 | 9 | 10 | 11 | 12 | 13 | 14 | 15 | 16 | 17 |
| Elongation | 180 | 320 | 321 | 320 | 325 | 323 | 180 | 182 | 160 | 150 |
| Transmittance | 91.24 | 93.04 | 93.14 | 93.45 | 92.81 | 92.99 | 91.43 | 91.24 | 91.48 | 91.15 |

As shown in Table 2, increase in elongation and improvement in transmittance of protective film could be confirmed within a certain range of glass transition temperature (Tg). A section showing elongation of over 300% was observed depending on glass transition temperature, and through this, it can be seen that elasticity of thermosetting polyurethane layer greatly increases in glass transition temperature range of 20° C. to 60° C. Additionally, when pigments are not dispersed in substrate layer 11 and pattern layer 15, it can be seen that visible light transmittance improves at a certain range of glass transition temperature, and it is preferable to use polyester-based resin with glass transition temperature range of 20° C. to 60° C. showing transmittance of 92% or higher, and it is even more preferable to use polyester-based resin with glass transition temperature range of 20° C. to 40° C. showing transmittance of 93% or higher.

### Evaluation of Elongation and Transmittance According to Resin Type

Furthermore, to evaluate elongation according to type of resin constituting substrate layer 11, transmittance tests were conducted on films formed by Example 10, Comparative Example 1, and Comparative Example 2, and elongation tests were conducted on films formed by Example 10 and Comparative Example 1. For elongation tests, samples were cut to 10 mm width and 150 mm length, then tested following standard test method of ASTM D638, while transmittance tests were conducted following method of COH-400 (equipment name); Jis K 7105/ASTM D1003.

TABLE 3

| | | Comparative | Comparative |
|---|---|---|---|
| | Example 10 | Example 1 | Example 2 |
| Haze (%) | 0.98 | 1.01 | 1.21 |
| Transmittance (%) | 93.14 | 91.25 | 89.21 |

Referring to Table 3, it can be confirmed that films with thermosetting polyurethane layer as substrate layer (11) according to present disclosure have transmittance measured about 2 to 4% higher compared to comparative examples, and haze below 1%, indicating good visibility. Additionally, films formed by Example 10 and Comparative Example 1 were elongated until fracture (permanent deformation), and elongation at fracture was measured. As a result of performing elongation tests three times for Example 10 and Comparative Example 1, as shown in Table 4 below, Comparative Example 1 showed elongation of about 320%, while Example 10 showed elongation of about 1,200%. As protective film with thermosetting polyurethane layer as substrate layer (11) shows excellent elongation, it can complement difficulties in application of conventional protective films. It can be confirmed that elongation rate in Table 4 has increased compared to elongation rate disclosed in Table 1 and Table 2, which is due to samples used for elongation tests in Table 4 having same width of 10 mm but increased length from 40 mm to 150 mm compared to samples used in Table 1 and Table 2.

TABLE 4

| | Elongation | Elongation | Elongation |
|---|---|---|---|
| Unit (%) | Test 1 | Test 2 | Test 3 |
| Comparative | 320 | 328 | 318 |
| Example 1 | | | |
| Example 10 | 1120 | 1200 | 1245 |

### Self-Healing Test

To evaluate self-healing properties according to type of resin constituting substrate layer (11), films formed by Examples 1 to 7 and Comparative Example 1 were stretched by applying same force, and then recovery of films after elongation was visually assessed. Additionally, length of films was measured after a certain time had elapsed from elongation to test recovery force.

TABLE 5

| | Example | Example | Example | Example | Example | Example | Example | Comparative |
|---|---|---|---|---|---|---|---|---|
| Unit(mm) | 1 | 2 | 3 | 4 | 5 | 6 | 7 | Example 1 |
| Before | 10 | 10 | 10 | 10 | 10 | 10 | 10 | 10 |
| Elongation | | | | | | | | |
| After | 28 | 32 | 32 | 32 | 32 | 32 | 28 | 28 |
| Elongation | | | | | | | | |
| After | 12 | 11 | 11 | 11 | 11 | 11 | 12 | 25 |
| Recovery | | | | | | | | |

As can be seen in Table 5 and FIG. 4, in case of protective films including substrate layer 11 as thermosetting polyurethane using polyester-based resin, within glass transition temperature range of 20° C. to 60° C., it can be confirmed that they stretch about 4 mm more when elongated with same force compared to protective films including substrate e layer of thermoplastic polyurethane (TPU). Particularly, when comparing recovered length of films after certain time has elapsed following elongation, it can be seen that recovery of films in Examples 1 to 7 is superior, and it can be observed that they have even more excellent recovery force within glass transition temperature range of 20° C. to 60° C.

Therefore, disclosed self-healing paint protection film is easy to apply due to its excellent elasticity, has improved paint visibility, and has superior self-healing properties in response to contraction and relaxation, making it suitable for use as a film to protect painted surfaces with curves, such as those on automobiles.

Detailed description above is illustrative of present disclosure. Furthermore, content described above represents preferred embodiments of present disclosure, and present disclosure can be used in various other combinations, modifications, and environments. In other words, modifications or changes are possible within scope of inventive concepts disclosed in this specification, scope equivalent to written disclosure, and/or scope of technology or knowledge in related field. Aforementioned embodiments describe best mode for implementing technical idea of present disclosure, and various modifications are possible depending on specific application areas and uses required for present disclosure. Therefore, detailed description of invention above is not intended to limit present disclosure to disclosed embodiments. Additionally, attached claims should be interpreted to include other embodiments.

1. A self-healing paint protection film comprising;
a substrate layer including thermosetting polyurethane resin and curing agent;
a top coating layer formed on one side of the substrate layer; and
an adhesive layer formed on other side of the substrate layer,
wherein the thermosetting polyurethane resin is polyester-based resin.

2. The self-healing paint protection film according to claim 1, wherein the polyester-based resin has a weight average molecular weight of 40,000 to 60,000 and a glass transition temperature of 20° C. to 60° C.

3. The self-healing paint protection film according to claim 2, wherein curing agent is an isocyanate-based curing agent or an isocyanate-based adduct, and the substrate layer includes 2 to 5 parts by weight of the curing agent based on weight of thermosetting polyurethane layer solution.

4. The self-healing paint protection film according to claim 1, further comprising a pattern layer formed between the substrate layer and the top coating layer.

5. The self-healing paint protection film according to claim 4, wherein the pattern layer has protrusions and depressions, and is formed by applying protrusions and depressions to a part of the substrate layer.

6. The self-healing paint protection film according to claim 5, wherein the pattern layer is formed by laminating a film with protrusions and depressions on the substrate layer, curing the film, and then removing the film with protrusions and depressions.

7. The self-healing paint protection film according to claim 6, wherein the substrate layer and the pattern layer have pigments mixed therein, and a colored pattern is formed on the pattern layer by the pigments.

8. The self-healing paint protection film according to claim 2, further comprising a pattern layer formed between the substrate layer and the top coating layer.

9. The self-healing paint protection film according to claim 3, further comprising a pattern layer formed between the substrate layer and the top coating layer.
